(19) United States
(12) Patent Application Publication
(10) Pub. No.: US 2009/0200048 A1
(43) Pub. Date: Aug. 13, 2009

(54) Modified box scraper system and apparatus with implement for fine grading

(76) Inventor: Michael Frederick, Atascadero, CA (US)

Correspondence Address: SANDRA LEE LIPKIN A LAW CORPORATION, P.O.Box 3518, VENTURA, CA, 93006, US

(21) Appl. No.: 12/069,618

(22) Filed: Feb. 11, 2008

(51) Int. Cl. A01B 63/10

(52) U.S. Cl. 172/1; 172/140

(57) ABSTRACT

A modified box scraper system that is fitted with a first, second third and fourth plurality of attachment means located on the rearward end and both sides of the box scraper allowing for the attachment of fine grade box extensions thereto. The fine grade box extensions are mirror images of each other and each attaches to one side of the box scraper. The fine grade box extensions are substantially similar in shape to the box scraper main body. Included on the box scraper's main frame are a visual level and a laser for greater accuracy in grading.

### BACKGROUND OF THE INVENTION

1. Field of the Invention

The present invention relates generally to the field of box scrapers commonly used behind tractors.

2. Description of the Prior Art

During construction, paving, grading and the like, typically in order to be prepared for the work to be done at a given site, contractors have had to move several pieces of grading equipment to the job site. One general piece of equipment is a tractor. Tractors commonly have box scrapers attached thereto.

Box scrapers are well-known in the art of construction, paving and other earth-moving activities. Box scrapers are attached to the back of a tractor and are height adjustable. A hydraulic system is typically in place that allows the box scraper to move in a vertical direction. Traditional box scrapers typically form a small, finite number of functions.

In addition to the box scraper, tractors have a front bucket that carries loads. Generally modifications have been made to the front bucket in the past in order to enable the tractor to perform more than one function. Modifications to buckets are known in the art, but are limited to a relatively few number of versatile operations. Some modifications have been made to box scrapers as well, but suffer from the same limitation as the front bucket with regard to the number of operations that can be performed.

By providing a system wherein some or all of the equipment needed for construction, paving, grading and the like can be utilized quickly and efficiently, contractors can save money on equipment, manpower, equipment moving costs and time. The instant invention seeks to provide such a system by innovatively modifying existing box scrapers to activate innovative grading implements that have been modified for use with the modified box scraper itself.

### SUMMARY OF THE INVENTION

The preferred embodiment of the present invention teaches a method and apparatus that provides for improved functionality and flexibility of a tractor. This method involves first the attachment of a modified box scraper apparatus on the back of a tractor through connection of the box scraper to a hydraulic system found on the tractor that allows for vertical movement of the box scraper. The box scraper is comprised of a main frame having a rearward end, a first side and a second side. The rearward end contains a first plurality of attachment means. The first side contains a second plurality of attachment means, and the second side contains a third set of attachment means. One of a variety of modified work implements are then attached to one or more of the attachment means.

The first plurality of attachment means is typically arrayed in a linear formation across the rearward end of the box scraper. The first plurality of attachment means is typically made up of female fittings designed to releasably accept male fittings found on the modified work implements. The second and third plurality of attachment means are also female fittings designed to releasably accept male fittings found on the modified work implements. Typically, these second and third plurality of attachment means are located on one or more locations on the first and second sides of the box scraper, around the perimeters of each side.

The first, second and third pluralities of attachment means also contain solid rubber block inserts that are placed therein to protect the female attachment means from being clogged with dirt, clay, mud, asphalt and other contaminants.

A fourth plurality of attachment means includes a first aperture located substantially in the top left corner of the rearward portion of the main frame; a second aperture located substantially in the top right corner of the rearward portion of the main frame; a third aperture located substantially in the bottom left corner of the rearward portion of the main frame; and a fourth aperture located substantially in the bottom right corner of the rearward portion of the main frame.

The modified work implement is further defined as a pair of fine grade box extensions, each of the fine grade box extensions being mirror images of each other for placement on either side of the box scraper, each of the fine grade box extensions further comprising a rearward facing panel; a first exterior side; and a second interior side having at least one protrusion for attachment to the box scraper.

The above method and apparatus can be further modified by defining that there is also included a laser on the main body portion of the box scraper.

The above method and apparatus can be further modified by defining that there is also included a visual level on the main body portion of the box scraper.

### BRIEF DESCRIPTION OF THE DRAWINGS

For a better understanding of the present invention, reference is to be made to the accompanying drawings. It is to be understood that the present invention is not limited to the precise arrangement shown in the drawings.

FIG. 1 is an isometric view of the modified box scraper.

FIG. 2 is a close up view of the female attachment means located on the rearward end of the box scraper.

FIG. 3 is a close up view of the female attachment means located on the sides of the box scraper.

FIG. 4 is an exploded view of the box scraper with the fine grade box extensions detached.

FIG. 5 is an isometric view of the box scraper with the fine grade extensions attached.

FIG. 6 is a top view of the box scraper with the fine grade extensions attached.

### DETAILED DESCRIPTION OF A PREFERRED EMBODIMENT

Turning to the drawings, the preferred embodiment is illustrated and described by reference characters that denote similar elements throughout the several views of the instant invention.

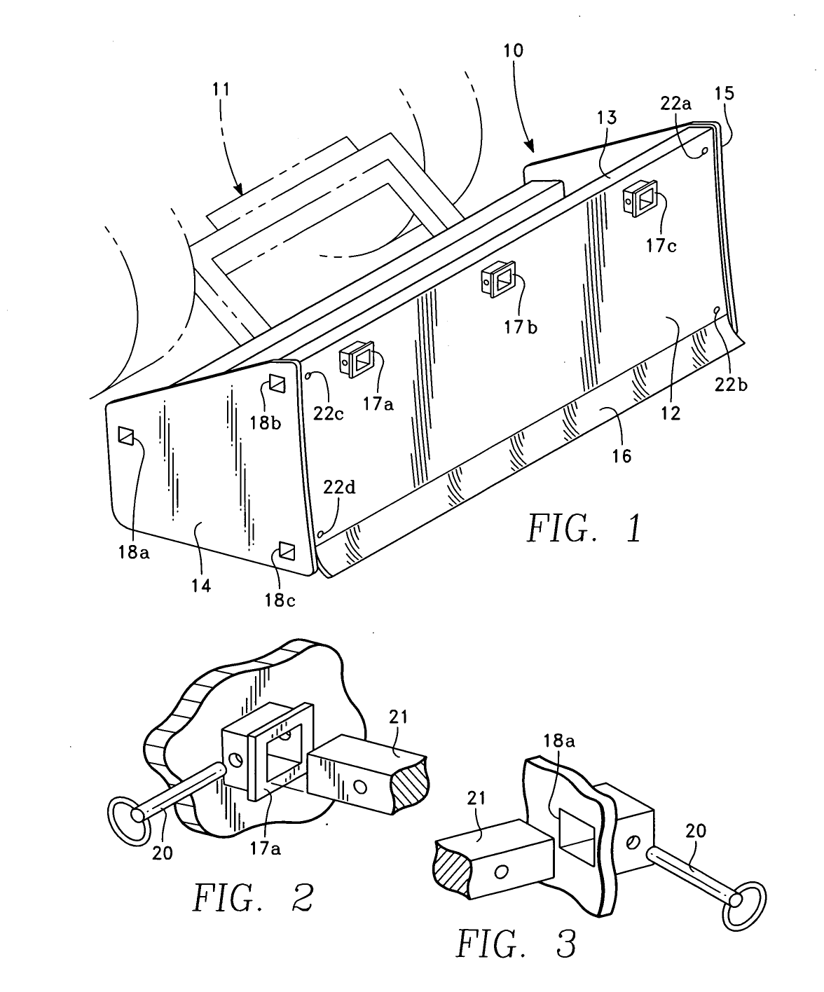

Referring now to the drawings. FIGS. 1-3 show the details of the modified box scraper 10 as it attaches the rear of a tractor 11. The box scraper 10 has a main frame 13 consisting of a rearward portion 12, a first side 14 and a second side 15. The bottom portion 16 of the rearward portion 12 can be beveled, but it is considered within the scope of this invention that the bottom portion 16 could also be flat.

The rearward end 12 of the box scraper 10 has a first plurality of attachment means 17a, 17b, 17c. The first plurality of attachment means 17a, 17b, 17c is typically arrayed in a linear formation across the rearward portion 12 of the box scraper 10 and is typically made up of female fittings that are designed to releasably accept various male fittings found on one or more of the work implements.

A second plurality of attachment means 18a, 18b, 18c are found on the first side 14 of the box scraper 10. A third plurality of attachment means 19a, 19b, 19c are found on the second side 15 of the box scraper 10. Attachable work implements can be variously attachable to any of these sets of attachment means 17a, 17b, 17c, 18a, 18b, 18c, 19a, 19b, 19c. A securing means, such as a pin 20 is used to secure the various work implements to the appropriate side of the box scraper 10.

All of the attachment means 17a, 17b, 17c, 18a, 18b, 18c, 19a, 19b, 19c also contain solid rubber block inserts (not shown) that are placed therein to protect the attachment means 17a, 17b, 17c, 18a, 18b, 18c, 19a, 19b, 19c from being clogged with dirt, clay, mud, asphalt and other contaminants. Each attachment means 17a, 17b, 17c, 18a, 18b, 18c, 19a, 19b, 19c is a female member that accepts a corresponding male member 21 from the appropriate work implement.

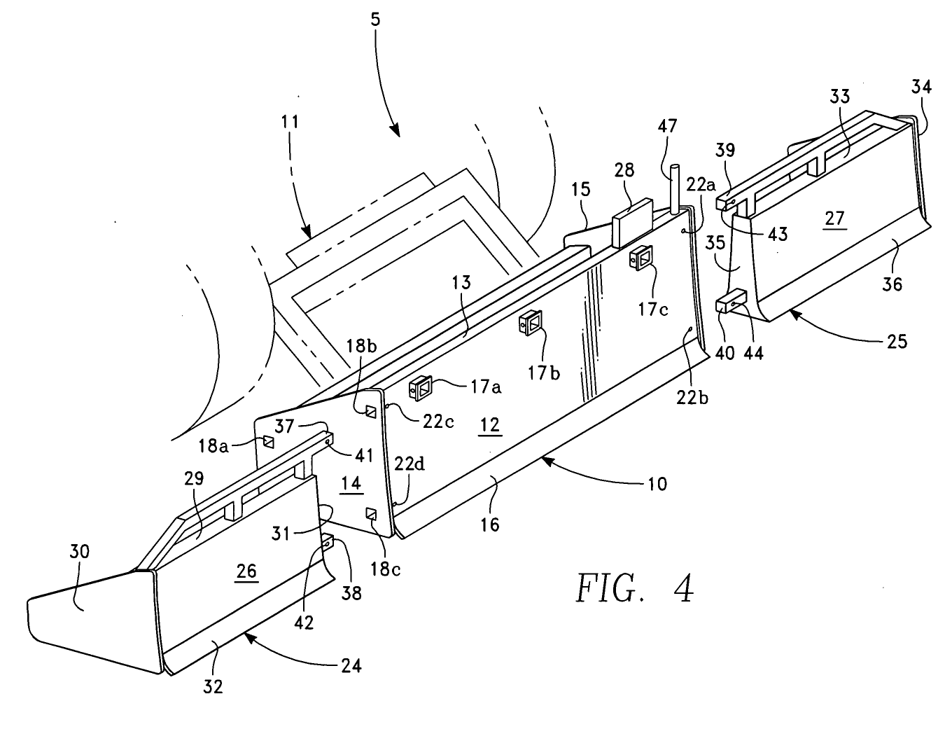

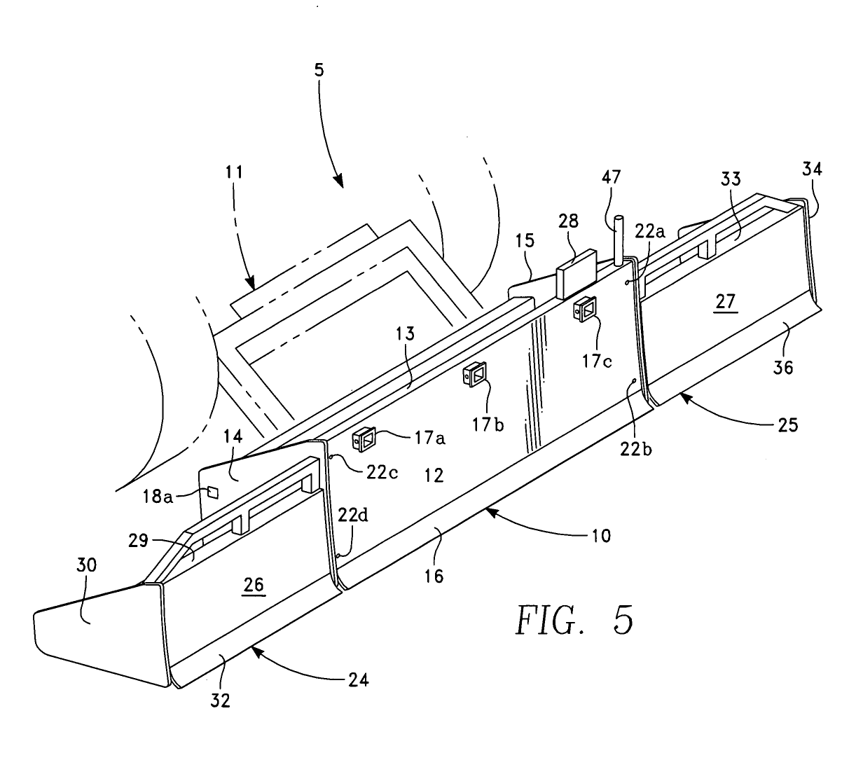

For the implement of the present invention, there is a fourth plurality of attachment means 22a, 22b, 22c, 22d on the rearward portion 12 of the box scraper 10 in the form of apertures for the placement therein of pins. As seen in FIG. 4, there are two side fine grade box extensions 24, 25 that attach to one to the first side 14 and the other to the second side 15 of the box scraper 10. The fine grade box extensions 24, 25 are basically mirror images of each other. The rearward portions 26, 27 of the fine grade box extensions 24, 25 have substantially the same structure as the rearward portion 12 of the box scraper 10, i.e., there is included on the first fine grade box extension 24 a main frame 29 consisting of a rearward portion 26, a first exterior side 30 and a second interior side 31. The bottom portion 32 of the rearward portion 26 can be beveled, but it is considered within the scope of this invention that the bottom portion 32 could also be flat.

Likewise, for the second box extension 25, there is a main frame 33 consisting of a rearward portion 27, a first exterior side 34 and a second interior side 35. The bottom portion 36 of the rearward portion 27 can be beveled, but it is considered within the scope of the invention that the bottom portion 36 could also be flat.

The fine grade box extensions 24, 25 allow an operator to fine grade base material to a width of fourteen and a half feet in a single pass. The addition of a laser control 27 on the main body portion 13 of the box scraper 10 allows the operator to precisely grade to exactly the required specification. This implement provides the capability to provide a wider pass than can be accomplished with most road graders, with the accuracy only a laser 27 can provide.

There is also a visual level 28 on the main body portion 13 of the box scraper 10 that the operator can easily see and can grade from level to 1% or more cross fall. Examples of uses for which this implement can be put include large parking lots or roadways, finish grade commercial pads, fine grade topsoil, football fields, running tracks, tennis courts and golf courses. If needed, one side can be removed to allow grading angles against buildings, and overhanging obstructions.

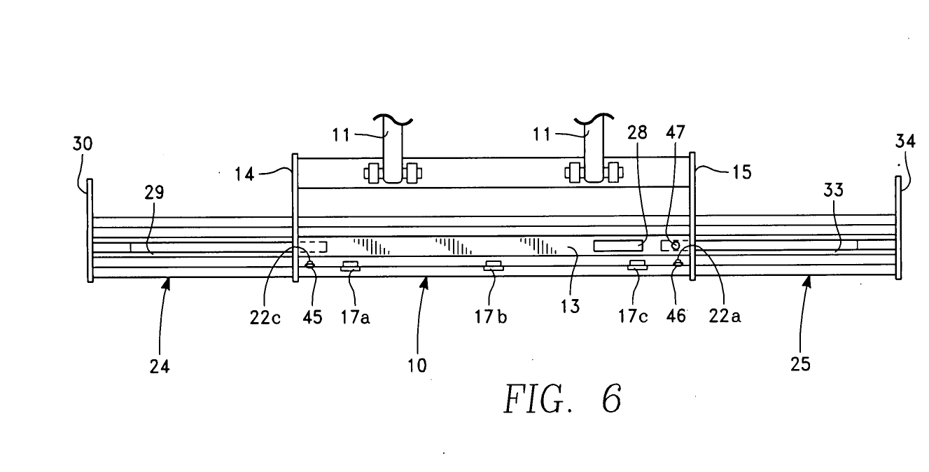

To attach the fine grade box extensions 24, 25 to the box scraper, there are included on the interior sides 31, 35 of each fine grade box extension 24, 25 protrusions 37, 38, 39, 40 that fit into the second and third plurality of attachment means 18a, 18b, 18c, 19a, 19b, 19c. In each of these protrusions 37, 38, 39, 40 there are apertures 41, 42, 43, 44. Once the protrusions 37, 38, 39, 40 are placed inside of the second and third plurality of attachment means 18a, 18b, 18c, 19a, 19b, 19c, these apertures 41, 42, 43, 44 align with the fourth plurality of attachment means 22a, 22b, 22c, 22d found on the rearward portion 12 of the box scraper 10. Pins 45, 46 can be placed inside of the fourth plurality of attachment means 22a, 22b, 22c, 22d (as seen in FIG. 6) and on through the apertures 41, 42, 43, 44.

The discussion included in this patent is intended to serve as a basic description. The reader should be aware that the specific discussion may not explicitly describe all embodiments possible and alternatives are implicit. Also, this discussion may not fully explain the generic nature of the invention and may not explicitly show how each feature or element can actually be representative or equivalent elements. Again, these are implicitly included in this disclosure. Where the invention is described in device-oriented terminology, each element of the device implicitly performs a function. It should also be understood that a variety of changes may be made without departing from the essence of the invention. Such changes are also implicitly included in the description. These changes still fall within the scope of this invention.

Further, each of the various elements of the invention and claims may also be achieved in a variety of manners. This disclosure should be understood to encompass each such variation, be it a variation of any apparatus embodiment, a method embodiment, or even merely a variation of any element of these. Particularly, it should be understood that as the disclosure relates to elements of the invention, the words for each element may be expressed by equivalent apparatus terms even if only the function or result is the same. Such equivalent, broader, or even more generic terms should be considered to be encompassed in the description of each element or action. Such terms can be substituted where desired to make explicit the implicitly broad coverage to which this invention is entitled. It should be understood that all actions may be expressed as a means for taking that action or as an element which causes that action. Similarly, each physical element disclosed should be understood to encompass a disclosure of the action which that physical element facilitates. Such changes and alternative terms are to be understood to be explicitly included in the description.

1. A method for providing for improved functionality and flexibility of a tractor, comprising:
attachment of a box scraper on the back of said tractor through connection of said box scraper to a hydraulic system found on said tractor that allows for vertical movement of said box scraper, said box scraper further comprising:
a main frame having a rearward end;
a first side having three female fittings wherein said female fittings are oriented towards each other in a substantially planar triangular orientation;
and a second side having three female fittings wherein said female fittings are oriented towards each other in a substantially planar triangular orientation releasable attachment of a first extension having a rearward facing panel that attaches to said first side of said main frame through two male fittings that are modified to fit into two of said female fittings on said first side wherein when attached said first extension and said rearward end of said main frame are aligned in substantially the same plane;
releasable attachment of a second extension having a rearward facing panel that attaches to said second side of said main frame through two male fittings that are modified to fit into two of said female fittings on said second side wherein when attached said second extension and said rearward end of said main frame are aligned in substantially the same plane;
securing of said first extension and said second extension to said mainframe through pins.

2-8. (canceled)

9. A method as defined in claim 1 wherein said main frame further comprises a laser.

10. A method as defined in claim 1 wherein said main frame further comprises a visual level.

11. An apparatus for providing for improved functionality and flexibility of a tractor, comprising:
a box scraper attached to the back of said tractor through connection of said box scraper to a hydraulic system found on said tractor that allows for vertical movement of said box scraper, said box scraper further comprising:
a main frame having a rearward end;
a first side having three female fittings wherein said female fittings are oriented towards each other in a substantially planar triangular orientation;
and a second side having three female fittings wherein said female fittings are oriented towards each other in a substantially planar triangular orientation wherein a first extension having a rearward facing panel attaches to said first side of said main frame through two male fittings that are modified to fit into two of said female fittings on said first side wherein when attached said first extension and said rearward end of said main frame are aligned in substantially the same plane; and
wherein a second extension having a rearward facing panel attaches to said second side of said main frame through two male fittings that are modified to fit into two of said female fittings on said second side wherein when attached said second extension and said rearward end of said main frame are aligned in substantially the same plane; and
wherein said first extension and said second extension are secured to said mainframe through pins.

12-18. (canceled)

19. An apparatus as defined in claim 11 wherein said main frame further comprises a laser.

20. An apparatus as defined in claim 11 wherein said main frame further comprises a visual level.
